(19) United States
(12) Patent Application Publication
(10) Pub. No.: US 2006/0279053 A1
(43) Pub. Date: Dec. 14, 2006

(54) Adjustable load support for hand trucks

(76) Inventor: John C. Reynolds, Rio, IL (US)

Correspondence Address: KRIEG DEVAULT LLP, ONE INDIANA SQUARE, SUITE 2800, INDIANAPOLIS, IN, 46204-2079, US

(21) Appl. No.: 11/449,055

(22) Filed: Jun. 8, 2006

Related U.S. Application Data
(60) Provisional application No. 60/690,605, filed on Jun. 11, 2005.

(51) Int. Cl. B62B 1/00

(52) U.S. Cl. 280/47.27

(57) ABSTRACT

A hand or lift truck includes an elongate frame having a first end and an opposite second end. The first end includes a handle section and the second end includes a support platform for supporting a load on a first side of the frame. The truck further includes a support member positioned between the first end and the second end. The length of the support member can be extended from the first side of the elongate frame to contact the load and provide support to the load as it is transported with the truck.

### CROSS-REFERENCE TO RELATED APPLICATIONS

The present application claims the benefit of the filing date of Provisional Application Ser. No. 60/690,605 filed on Jun. 11, 2005, which is incorporated herein by reference in its entirety.

### BACKGROUND

Conventional hand trucks are used to move loads that are too awkward and heavy to be conveniently carried by hand. Many loads which would preferably be moved using hand trucks do not fit conveniently on hand trucks so must either be carried by several people by hand, or be precariously balanced on a hand truck.

Specialized non-adjustable fixtures have been designed for hand trucks which permit securing specific loads, such as large and awkward television sets, but these are limited for use in their designed application.

### SUMMARY

The present invention is an improvement for hand trucks that permits conveniently securing many differently shaped awkward loads on hand trucks by providing quickly and conveniently adjustable load supporting extension assemblies. The adjustable extensions remain on the truck when not in use by being quickly and conveniently stowed out of the way so the hand truck can be used as a conventional hand truck. No separate tools are required for activating or adjusting the adjustable extensions. The adjustable extensions can be built into the original design of hand trucks, or they can be attached to existing hand trucks. The adjustable assemblies can be retrofitted to existing hand trucks by bolting on, as in the preferred embodiment, or attached by other means such as by welding, riveting, adhesives, etc. The adjustable support assemblies can be attached to hand trucks on rails or by other means that permit vertically slideably adjusted to any vertical position on the rails.

### BRIEF DESCRIPTION OF THE DRAWINGS

FIGS. 1A and 1B are side views of a hand truck with an adjustable extension stowed in FIG. 1A, and with an adjustable extension extended in FIG. 1B.

FIG. 2 is a partial sectional vertical view of a hand truck with the adjustable extension extended.

FIGS. 3A, 3B, 3C and 3D are side views of a second embodiment.

### DETAILED DESCRIPTION OF THE ILLUSTRATED EMBODIMENTS

For the purposes of promoting an understanding of the principles of the invention, reference will now be made to the embodiments, or examples, illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

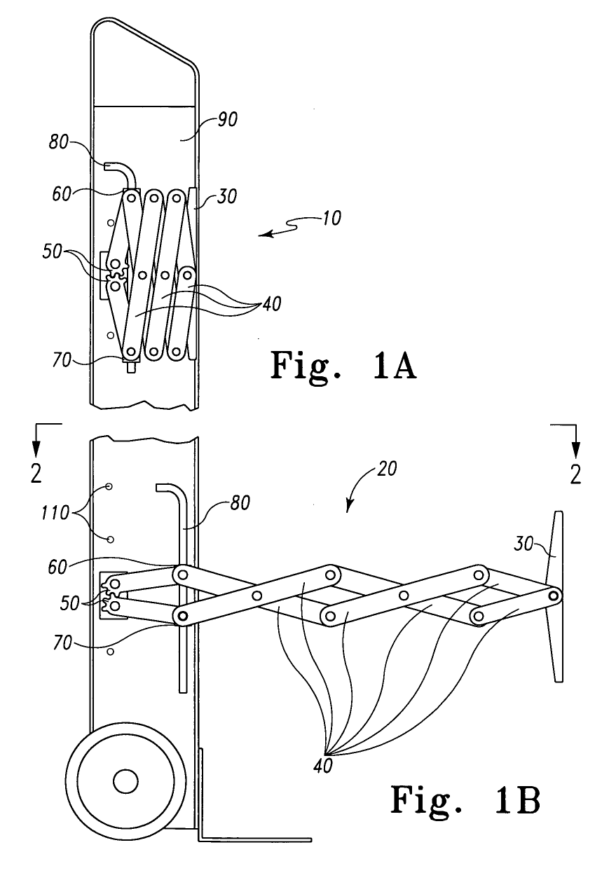

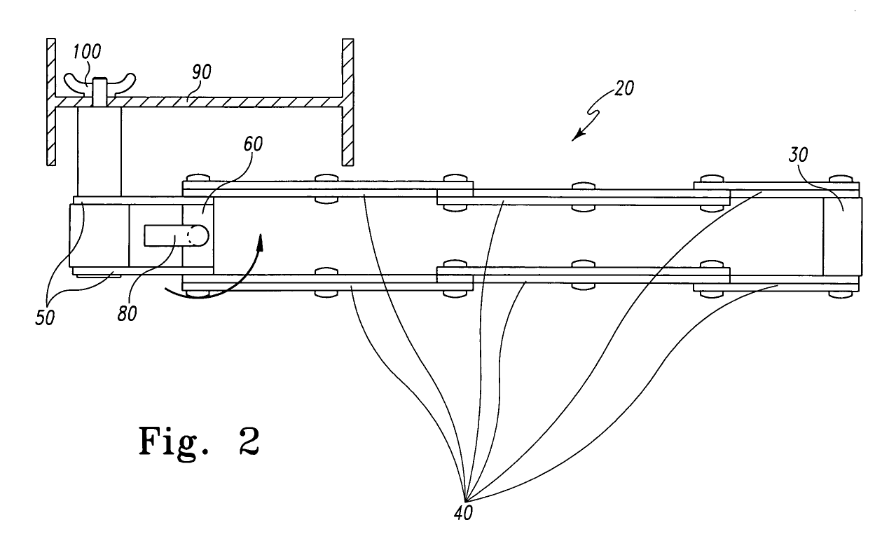

Referring now to FIGS. 1A and 1B which show a side view of a hand truck equipped with the preferred embodiment adjustable load support assemblies 10 in FIG. 1A and 20 in FIG. 1B. FIG. 1A shows load support assembly retracted and stowed. FIG. 1B shows load support assembly 20 extended. Adjustable load support assemblies 10 and 20 are attached to hand truck 90 by wing nut and bolt 100 (of FIG. 2). Other attaching means can be employed. The placement of adjustable load support assemblies 10 and 20 on hand truck 90 can be vertically changed by moving adjustable support assemblies 10 and 20 to a plurality of selectable positioning holes 110 in hand truck 90. Support assemblies 10 and 20 can also be mounted on rails or other attaching means on the sides hand truck 90 or to permit vertically changing the position of support assemblies 10 and 20. In the preferred embodiment scissor elements 40 terminate on the outer ends of load support assemblies 10 and 20 at support pads 30.

In FIG. 1A the front face of support pad 30 of load support assembly 10 is retracted behind the front face of hand truck 90. When load support assembly 10 is retracted, as in FIG. 1A, hand truck 90 can be used in a conventional manner. In FIG. 1B, support pad 30 of support assembly 20 is projected well forward of the front face of hand truck 90. Extension of adjustable load support assembly 20 can be adjusted to precisely the correct extension length to place support pad into secure contact with the load.

Many items, such as large and fragile television sets and other household appliances which are moved between appliance stores and customers' homes are often designed with such irregular shapes that they cannot be securely stabilize on conventional hand trucks, and so must be carried by hand by several people. It is well appreciated that manually carrying heavy, awkward loads often results in back injuries and/or damage to the item being moved. Employment of the adjustable load support permits safely and conveniently moving many irregularly shaped heavy loads that would otherwise require hand carrying.

In the preferred embodiment the extension means is an adaptation of a conventional scissors lift. In order to make use of the adjustable load support, the irregularly shaped load is placed on the hand truck in the conventional manner with part of the load resting against the hand truck. Then to fully support the otherwise unsupported portion of the load, adjusting screw 80 is rotated causing the load support pad 30 to move into contact with the load. One end of adjusting screw 80 is provided with right hand threads fitting with right hand nut 60. The other end of adjusting screw 80 is provided with left hand threads fitting with left hand nut 70.

Rotating hand adjusting screw 80 moves right hand nut 60 and left hand nut 70 toward or away from each other each other, depending upon which direction adjusting screw 80 is rotated. Drawing right hand nut 60 and left hand nut 70 together causes scissors elements 40 to extend support pad 30 forward into contact with the load. Rotation of adjusting screw 80 to move support pad 30 into secure contact with the load, effectively customizes the hand truck to fit the load. In addition to protecting the loads, employment of the adjustable load support results in labor savings as well as preventing personnel from injuries.

With support pad 30 resting against the load, the securing strap (not shown) of the hand truck is placed around the load and tightened. Geared scissors elements 50 cause scissors elements 40 to extend and retract support pad 30 straight forward and rearward. Without geared scissors elements 50 meshed with each other, scissors elements 40 with support pad 30 would not project straight forward, but would be pulled down at the front by gravity.

Refer now to FIG. 2 which is a vertical partial sectional view of the hand truck of FIG. 1. Adjustable load support 20 is attached to hand truck 90 by means of wing nut 100. Other attaching means can be provided. Support pad 30 is pivotably mounted on the ends of scissors elements 40. The opposite ends of scissors elements 40 are attached to geared scissors elements 50.

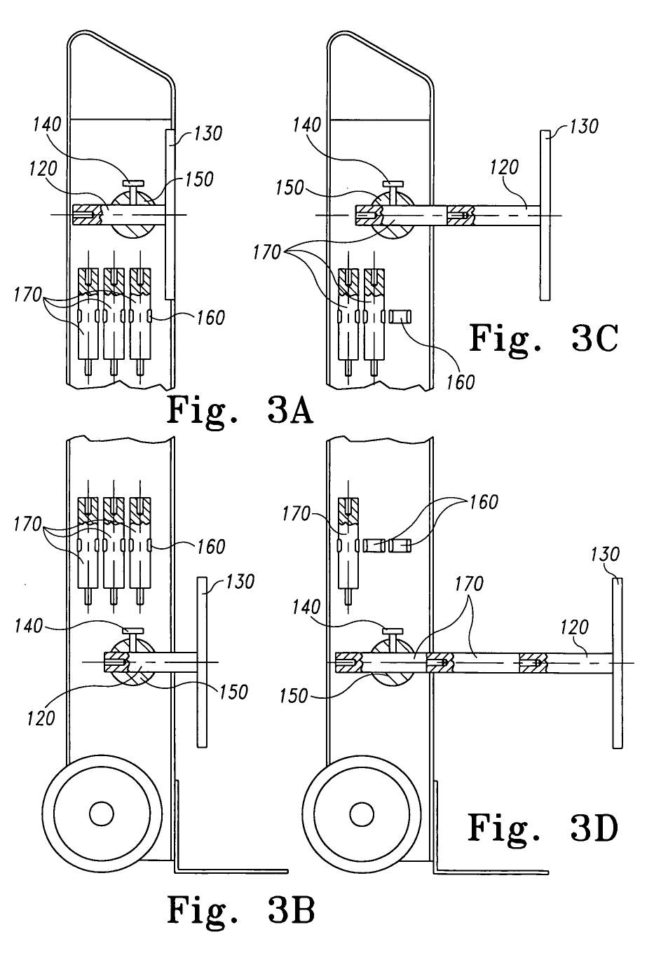

Refer now to FIG. 3A which is a side view of a second embodiment of the invention. Support pad 130 is mounted on pad extension 120. Support pad 130 is retracted behind the forward face of the hand truck. Pad extension 120 is secured in mounting block 150 by locking screw 140. Auxiliary extension elements 170 are retained in clips 160.

Refer now to FIG. 3B in which locking screw 140 has been loosened, and support pad 130 with pad extension 120 has been moved forward and locking screw 140 re-tightened.

Refer now to FIG. 3C in which one auxiliary extension element 170 has been removed from one of the clips 160. Auxiliary extension element 170 has been added to the base of pad extension 120. Locking nut 120 has been loosened to release pad extension 120 and to receive auxiliary extension element 170. Locking screw 140 has been re-tightened to retain auxiliary extension element 170 in position along with pad extension 120 with support pad 130.

Refer now to FIG. 3D which is like 3C, except two auxiliary extension elements 170 have been employed. It should be readily evident that adjusting means other than a scissors lift arrangement or auxiliary extension elements could be employed to provide the adjustable supporting means for the invention.

Although only a few exemplary embodiments of this invention have been described in detail above, those skilled in the art will readily appreciate that many modifications are possible in the exemplary embodiments without materially departing from the novel teachings and advantages of this invention. Also, features illustrated and discussed above with respect to some embodiments can be combined with features illustrated and discussed above with respect to other embodiments. Accordingly, all such modifications are intended to be included within the scope of this invention.

What is claimed is:

1. An apparatus for moving a load, comprising:
an elongate frame extending between a first end and a second end, wherein said first end includes a support platform extending from a first side of said elongate frame for supporting the load and at least one wheel attached thereto for moving said frame along a surface; and
at least one adjustably extendable support member attached to said frame between said first end and said second end of said frame, said adjustably extendable support member being adjustable to a fixed length extending from said first side to maintain contact with the load supported on said platform.

2. The apparatus of claim 1, wherein said adjustably extendable support member includes a support pad and said adjustably extendable support member extends between a first end and a second end, said first end is structured to attach to said elongate frame and said second end is structured to attach to said support pad.

3. The apparatus of claim 2, wherein said frame includes a number of positioning holes spaced holes spaced therealong and said first end of said adjustably extendable support member is removably attachable to any one of said number of positioning holes to adjust a position of said adjustably extendable support member along said frame.

4. The apparatus of claim 2, wherein said support pad is pivotally attached to said second end of said adjustably extendable support member.

5. The apparatus of claim 1, wherein said adjustably extendable support member comprises a scissors element including a first end and an opposite second end, wherein said first end of said scissors element is attached to said elongate frame and said second end of said scissors element includes a support pad.

6. The apparatus of claim 5, wherein said support pad is pivotally attached to said second end of said scissors element.

7. The apparatus of claim 5, further comprising an adjusting screw threadingly engaged to said scissors element, wherein said adjusting screw is rotatable in a first direction to elongate said scissors element to extend said support pad away from said first side of said frame and to rotate in a second direction to contract said scissors element to retract said support pad toward said first side of said frame.

8. The apparatus of claim 7, wherein said scissors element further includes geared scissors elements at said first end, said geared scissors element being structured to mesh with one another to maintain said scissors element in a predetermined orientation relative to said frame as said scissors element is extended from or retracted toward said frame.

9. The apparatus of claim 1, wherein said elongate frame further includes a mounting block between said first and second ends to slidably receive said adjustably extendable support member, said mounting block further including a locking member to secure said adjustably extendable support member in position relative to said frame.

10. The apparatus of claim 9, wherein said adjustably extendable support member comprises an extension element having a first end and a second end, said first end of said extension element being engaged with a support pad and said second end of said extension element is structured to slidably engage with said mounting block.

11. The apparatus of claim 10, wherein said adjustably extendable support member further includes at least one auxiliary extension element, said at least one auxiliary extension element including a first end and an opposite second end, wherein said first end of said auxiliary extension element is engageable with said second end of said extension element to extend said extension element from said first side and said second end of said auxiliary extension element is structured to slidably engage with said mounting block.

12. The apparatus of claim 1, wherein said at least one adjustably extendable support member is located toward said first end of said elongate frame and further comprising a second adjustably extendable support member located toward said second end of said elongate frame, said second adjustably extendable support member being adjustable to a fixed length extending from said first side to maintain contact with the load supported on said platformn.

13. An apparatus for moving a load, comprising:
an elongate frame including:
a handle portion;
a platform structured to support the load on a first side of the frame; and
at least one wheel attached to said frame to facilitate movement of the load supported by said frame; and
at least one extendable support member, said extendable support member being structured to transversely extend from said first side of said elongate frame to a desired fixed length from said elongate frame to contact the load and to retract transversely to said first side of said elongate frame for storage in said elongate frame.

14. The apparatus of claim 13, wherein said elongate frame further includes a second side opposite said first side and wherein said extendable support member is situated in between said first and second sides when stored in said elongate frame.

15. The apparatus of claim 13, wherein said extendable support member comprises a scissors element including a first end and an opposite second end, said scissors element including a pair of interdigitating gears at said first end and an adjusting screw engaged to said first end, wherein said interdigitating gears and said adjusting screw are structured to extend said scissors element away from said first side of said elongate frame to said fixed length and retract said scissors element toward said first side of said elongate frame for storage in said elongate frame.

16. The apparatus of claim 13, wherein said elongate frame further includes a receiver channel and a locking member communicating with said receiver channel and wherein said extendable support member comprises at least one extension member coupled to a support pad, said extension member is structured to slidably engage said receiver channel and said locking member is structured to maintain said extension member relative to said receiver channel at a selected position with said support pad extending from said first side of said elongate frame.

17. The apparatus of claim 16, further including at least one auxiliary extension member, wherein said at least one auxiliary extension member is structured to engage said extension member to extend the length of said extendable support member extending from said first side of said elongate frame.

18. The apparatus of claim 17, wherein said elongate frame further includes at least one clip member, said clip member being structured to retain said at least one auxiliary extension member on said frame when said auxiliary extension member is not used to extend said support member from said first side of said elongate frame.

19. A method for moving a load, comprising:
providing a two wheel lift truck, the lift truck including an elongate frame having a first end and an opposite second end, wherein the first end includes a handle section and the second end includes a support platform for supporting the load on a first side of the frame, the lift truck further including a support member positioned between the first end and the second end;
placing the load onto the support platform of the lift truck;
extending a length of the support member from the first side of the elongate frame;
contacting the load with the support member to stabilize the load on the support platform while the support member remains engaged to the frame; and
moving the load with the lift truck with the load on the support platform and the support member in contact with the load.

20. The method of claim 19, wherein the support member comprises a scissors element including a first end and an opposite second end, the scissors element including:
a pair of interdigitating gears at the first end of the scissors element;
an adjusting screw operable to extend and retract the support member relative to the first side of the frame; and
a support pad mounted to the second end of the scissors element.

21. The method of claim 19, wherein extending the length of the support member includes slidably advancing a number of extension elements through a receiver channel until a support pad engaged to an end of a first of the number of extension elements contacts the load.
